(19) United States
(12) Patent Application Publication
(10) Pub. No.: US 2007/0011607 A1
(43) Pub. Date: Jan. 11, 2007

(54) Business method, system and process for creating a customized book

(75) Inventors: Leslie H. Lazareck, Las Vegas, NV (US); Sherry A. Fehrmann, Henderson, NV (US)

Correspondence Address: BUCHANAN, INGERSOLL & ROONEY PC, POST OFFICE BOX 1404, ALEXANDRIA, VA, 22313-1404, US

(73) Assignee: Sher & Cher Alike, LLC, Las Vegas, NV (US)

(21) Appl. No.: 11/519,642

(22) Filed: Sep. 11, 2006

Related U.S. Application Data
(63) Continuation-in-part of application No. 10/970,965, filed on Oct. 22, 2004.
Application No. 10/970,965 is a continuation of application No. 10/765,298, filed on Jan. 26, 2004, now abandoned.
(60) Provisional application No. 60/446,056, filed on Feb. 7, 2003.

(51) Int. Cl. G06F 17/00

(52) U.S. Cl. 715/530; 715/515

(57) ABSTRACT

A business method, system and process is described by which a person is enabled, through payment of money, or its substitute, to produce a customized book. The process for producing the customized book includes the selection of one of a plurality of previously developed stories having fixed text and variable text, associated fixed illustrations and variable illustrations. The process further includes the input of certain customizing information that is used to personalize the story and accompanying illustrations to relate to an intended recipient of the book. A computerized process utilizes the customizing information to revise the text and illustrations in accordance with the present invention. The resulting customized text and associated customized illustrations are then integrated with unrevised text and illustrations to produce the customized book. The customized book may optionally be combined with a customized cover.

### RELATED APPLICATION DATA

The present application is a continuation-in-part application of U.S. patent application Ser. No. 10/970,965, entitled “Customized Book and Method of Manufacture,” filed Oct. 22, 2004 by Applicants herein which claims priority to U.S. patent application Ser. No. 10/765,298, entitled “Customized Book and Method of Manufacture,” filed Jan. 26, 2004 by Applicants herein which, in turn, claimed the priority of U.S. Provisional Application Ser. No. 60/446,056, entitled “Customized Book and Method of Manufacture,” filed Feb. 7, 2003 by Applicants herein.

### FIELD OF THE INVENTION

The present invention relates generally to a business method, system and process by which a person can create a customized book, and more specifically, to a computerized process that enables one to customize previously generated story-line text and associated illustrations to create a customized book that reflects certain attributes or characteristics, or is consistent wilt certain attributes or characteristics, of an intended recipient of the book, the subject process forming the basis of a business method incorporating the process.

### BACKGROUND OF THE INVENTION

It has long been desirable to create customized documents, specifically books, for a variety of purposes and to comply with users' intentions. For example, Kraynak et al., U.S. Pat. No. 3,892,427, discloses pre-printing non-variable copy with gaps therein for receiving pre-publication information or verbiage. Customized copy is created and printed into the gaps in the pre-printed non-variable copy to create a customized text of a book. The drawback of this method is that the customized copy is limited to the size of the gaps in the pre-printed copy. Thus, customized copy that is too long or too short for the gap will not be aesthetically pleasing and could interfere with adjacent pre-printed copy. Also, such a system does not address customization of illustrations.

It is also known in the art to automatically merge data into a template using word processing technology to create a number of customized documents using the same or similar format. One particular application of this technology is the creation of customized books. For example, Chanenson et al., U.S. Pat. No. 5,765,874, describes customizing comic books by merging variable text with fixed text to generate integrated text which is formatted and printed into pre-printed “balloons” in pre-printed illustrations.

There are drawbacks to this approach, as with other approaches that use pre-printed pages with illustrations already appearing thereon, such as, for example, that disclosed by Kalisher in U.S. Pat. No. 5,213,461. First, registration of the text with the illustrations can be difficult and, more likely than not, many pages will include registration or alignment errors between the text and the pre-printed illustrations. This can result in a text that is difficult to read since it overlaps the illustrations.

Secondly, with pre-printed illustrations, there is no opportunity to customize the illustration so that details thereof are made to be consistent with to the customized text. This can be a significant deficiency if the customized book is intended for a child who is likely to be as interested, if not more interested, in the illustrations as he is in the text.

One response to the inability to customize illustrations is shown in D'Andrea, U.S. Pat. No. 5,238,345, in which scanned photographs and customized text are superimposed into generic illustrations to create a customized book. For example, D'Andrea discloses utilizing a generic illustration of the body of a basketball player. The illustration is then customized by superimposing a photograph of a subject's face into a gap where the basketball player's head would appear and printing a subject's name onto the basketball player's uniform.

Such a system has drawbacks of its own such as, again, registration errors in the superimposition of the images, and the strange, distracting effect of a superimposed photograph of a face onto a body when the face and body clearly have incompatible shapes, sizes, and positioning. Moreover, such a system requires the use of some amount of expertise in properly placing the photographs into the generic illustrations and is, most likely, beyond the skill of an ordinary consumer.

Accordingly, it is an objective of the present invention to provide a process for producing customized books for particular customers.

Another objective of the present invention is to provide a business method, system and process for producing customized books in a manner that can be commercially exploited.

Another objective of the present invention is to provide a business method, system and process for producing customized children's books in a manner that can be commercially exploited on either a small scale or a large scale.

Yet another objective of the present invention is to provide a business method, system and process of the type described which can be commercially exploited by embodying the invention in a self contained, standalone mechanism that can be addressed by an unskilled user who can be electronically prompted to input information and payment, and receive in return a customized book product produced by the system without human intervention.

Still another objective of the present invention is to provide a business method, system and process of the type described which can be commercially exploited by embodying the invention in a remotely positionable customer interface and book production mechanism that is in wireless or wired communication with a local terminal that can be addressed by an unskilled user who can input information and payment, and receive in return, a customized book product.

### SUMMARY OF THE INVENTION

Briefly, a presently preferred embodiment of the present invention includes a business method, system and process for producing customized books using a novel process and method of creating and/or manufacturing a customized book. The customized book has fixed text combined with customizable text, and at least one customizable illustration. In accordance with the present invention, a User, or customer, is enabled to produce a customized version of a story book by addressing a computerized interface, registering, selecting a particular book from a plurality of books, inputting customizing information and paying a fee. The customized book is then created by an automated process in which variable text and associated illustrations are modified in response to the input of customizing information provided by the User. Alternatively, a number of additional fixed text components and illustrations or component parts of illustrations can also be made available for selection by the User, and used by the system, to create an alternative form of a customized book.

In accordance with the present invention, customizing data is input at an input device or “interface”, and such data is used by an associated data processor to develop customized text and/or graphics based on the input customizing data. The customized text is integrated into the fixed text to generate composite text consisting of both customized text and fixed text.

At least one customized illustration may also be included among several fixed illustrations in the customized book. The customized illustration is created using customizing image data input by the User. Optionally, the input customizing image data may be derived from a scanned photograph, and the customized illustration may be generated based on customizing image data taken therefrom. The customized illustration is then integrated into the customized book along with the composite text. In an optional embodiment with fixed illustrations, the fixed illustrations and customized illustrations may be presented separately, or the customized illustration may be integrated into or among fixed illustrations to create composite illustrations.

The integrated customized illustrations and composite text are output to an output device for storage, local printing or transmission to a remote site for storage and/or printing. The illustrations and text may be printed by a printer in single or multifold pages, and on one or both sides of pages. In an optional embodiment in which the pages are printed in folios, the printed folios may be sorted and folded to form a “signature”.

In an alternative embodiment, the pages, optionally a signature of pages, are nested into an adhesive sheet with adhesive on a surface facing outward from the signature. The signature and adhesive sheets are then secured to one another, such as by use of staples, stitching, adhesive, or other fastener, and a cover is secured to the adhesive sheet.

The ChannelBind System http://www.channelbind.com is a proprietary system for binding hardcover (soft and clear cover) books and documents produced on-demand, from one to several thousand copies. The technology is unique and patented, and above all, the method is easy and quick. A document can be bound in less than 15 seconds by simply “crimping” the channel within the cover. Both of ChannelBind's binding systems require no heat, no glue, no electricity and no hole punching. The systems are so simple, they are revolutionary.

The cover may also be customized. This customization may take the form of adhering a customized label or slip sheet to a portion of, or about all of, the cover. If only a portion of the cover is covered by the label, a portion of the remainder of the cover may be printed or pre-printed. The cover may also be customized through use of a die-cut process.

These and other objectives and advantages of the present invention will become apparent to those skilled in the art following a reading of the detailed description thereof illustrated in the several figures of the drawing.

### BRIEF DESCRIPTION OF THE DRAWINGS

FIG. 1 is a partially broken perspective view of a stand alone terminal or kiosk of a form in which the present invention may be embodied;

FIG. 2 is a block diagram generally illustrating the principal operative steps undertaken in implementing an embodiment of the method, system and process of the present invention;

FIG. 3a is a flowchart illustrating the steps taken by a User in interfacing with a book customization system in accordance with the present invention;

FIG. 3b is a flowchart illustrating the principal operative steps executed by the system software in using the User input data to produce a customized book in accordance with the present invention;

FIG. 3c is a chart listing some of the alternatives or future enhancements that might be added to the described embodiment of the present invention;

FIG. 4 is a representation of a display “screen” that might be displayed to a User to prompt him to enter certain types of personalization information (which may be different for each story) in accordance with the present invention;

FIGS. 5-8 are representations of screen shots that might be presented to a User on a system interface display to prompt him to enter various types of personalization and characterizing information in accordance with the present invention;

FIG. 9 is a schematic illustration of a data File containing personalization and characterizing information obtained from the User and stored in system memory for use in accordance with the present invention;

FIG. 10 is a schematic representation of a CartoonKid Variables Database and several associated illustrations that might be included in a customized book developed in accordance with the present invention;

FIG. 11 is a schematic representation of a Graphic Text Database of a type that might be used in developing a customized book in accordance with the present invention; and

FIGS. 12a-12c are simplified examples of customized book pages having content progressively modified in accordance with the present invention.

### DESCRIPTION OF THE PREFERRED EMBODIMENTS

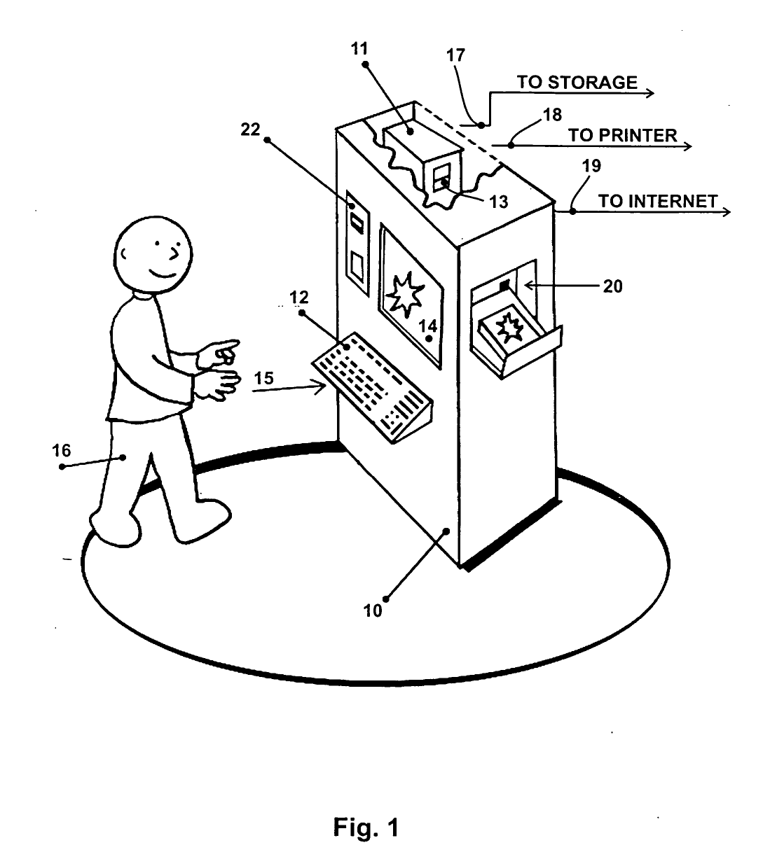

Referring now to the drawings wherein like parts shown in the several figures are referred to by like numerals throughout, an apparatus for implementing a business method, system and process in accordance with the present invention is generally depicted in FIG. 1. Such apparatus might include a computerized unit 10 having a keyboard 12 and display screen 14 that collectively serves as a user interface means 15 between a User 16 and an included data processor 11 and its associated software application housed in the unit 10. The data processor 111 may be as simple as a general purpose desktop computer having adequate local memory 13 (or linkage 17 to remote electronic storage, not shown) and a local printer housed within the device housing at 20 (or linked to a remote printer wirelessly or by a linkage 18). The memory 13 will contain system operating software, customizing application software, and customizable story data. Memory 13 (Note that “memory” refers to both RAM and hard drive storage) is also adapted to receive and store input customizing data. Note that the customizing application driving the processor 11 can be implemented in either software or firmware.

The unit 10 may be a simple combination of computer, display screen and printer combination, or be embodied as a fully functioning kiosk having a user interface, computational capability, an internal printing facility, and a financial transaction apparatus 22 with appropriate revenue handling mechanism for accepting and processing cash and/or credit cards. In the illustrated kiosk representation, the stand alone unit may also be linked to remote systems via modem and telephone line connections, and/or to the Internet through the respective lines 17, 18 and 19, as well as by appropriate wireless communications mediums. Furthermore, the kiosk may be linked to a network of similar units, perhaps sharing a common system server facility that provides financial transaction and records keeping assistance, as well as library function.

In accordance with the present invention, a person seeking to generate a customized book for another, such as a son or daughter, niece or nephew, etc., perhaps in recognition of a special occasion such as a birthday, is enabled to produce such book by 1) registration and/or the payment of money, or its substitute, at the kiosk 10, 2) addressing the kiosk via its interface including the keyboard 12 and video display screen 14, to review and select one of a plurality of pre-stored book stories, the titles and perhaps abstracts of which may displayed on the screen 14, and 3) the input of customizing data that may include personal information relating to the intended recipient. Upon completion of the User input, the unit will process and quickly produce a customized book at the kiosk's production outlet 20.

As will be described more fully below, the kiosk unit contains electronic and mechanical processing equipment and a collection of book story data. As far as the User is concerned, his involvement in the process for producing the customized book may be said more generally to include the selection of one of a plurality of book stories, the payment of a fee, and the input of certain customizing information. A computerized process driven by the customizing application and implemented in accordance with the present invention then utilizes the customizing information to revise the variable text and variable illustrations associated with the selected story, and to cause the customized book to be produced.

For purposes of the description below, the term “User” is intended to refer to the one who provides the customizing data for the customized book, while the term “Recipient” refers to the one to whom the customizing data relates. While the User and the Recipient can be the same person, it is usually the case that the User and the Recipient are different. As an example, the subject of the customized book could be a child, a pet, or any other person, place, thing, or event. Furthermore, even though the examples given below refer to children's books, these examples are to be considered illustrative and not limiting in scope.

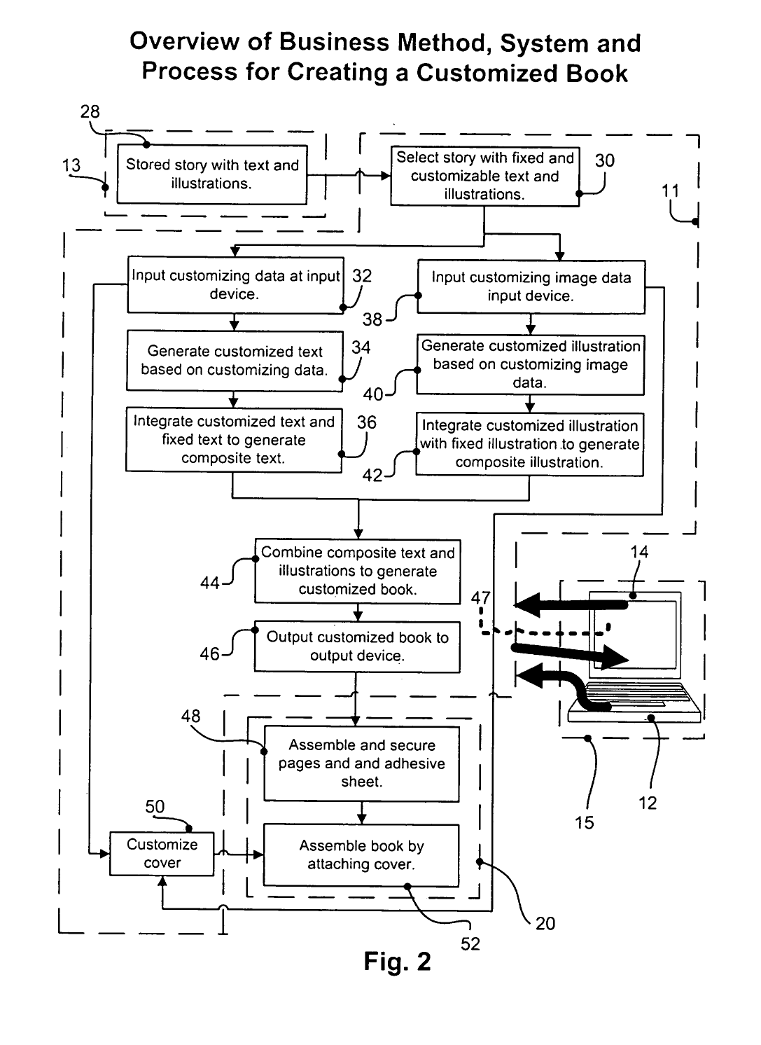

In FIG. 2, a functional block diagram is provided showing the principal operational functions executed as the present invention is implemented. In this figure, the several functioning devices of the apparatus depicted in FIG. 1 are identified by the numbered dashed boxes surrounding the several function boxes. As suggested above, the process can be implemented in a number of different formats including application software stored in a local memory 13 and operating on a general purpose computer 11, or application software operating over a local or wide area computer network such as the Internet.

If the method is implemented in software operating on a multi-user general purpose system computer, it is contemplated that the user interface might be the home computer or laptop of the User and be remotely linked to a system service provider via the Internet. In such case, the User would input the required personalizing information at his computer, but the book would be produced at some other site and forwarded to the User. For purposes of the present discussion, it is presumed that the interface illustrated in FIG. 1 is part of a functioning kiosk operatively linked to a service provider and is in direct communication with the User in person or by telephone or e-mail connection. Alternatively, the kiosk could be a local component of a publicly available shop or kiosk, but associated with a larger system to which it is communicatively connected.

Regardless of the implementation, the data processor associated with the service provider communicates with a memory device 13 that stores an application program containing instructions for practicing the subject process. It also contains the selected book story data and other data, as described in greater detail below. The data storage device or memory device 13 can take any form including optical media, magnetic media, random access memory (“RAM”), read only memory (“ROM”), electrically programmable read only memory (“EPROM”), electrically alterable read only memory (“EAROM”), electrically erasable programmable read only memory (“EEPROM”), or any other form of memory device.

As suggested by the drawing, the data processor 11 receives User input from a connected interface means 15 that, in addition to being comprised of a keyboard 12 and display screen 14, as mentioned above with respect to FIG. 1, the interface means 15 may take any suitable form, including an image capture device such as a camera or scanner, or a data input device such as a wireless keyboard, mouse, or the like, a wireless or wired communications device for importing data from another data source, or any other device that can capture data for transport to the data processor.

After receiving the customizing data, and processing the data using the book customizing software, the processor 11 outputs the results of the subject process to a connected output device 20 that can take many forms including a temporary or intermediate data storage device, such as an optical or magnetic storage device for temporarily or permanently storing the output data on optical or magnetic media, a video display device, or a printer with associated book binding mechanisms.

As previously pointed out above, an important objective of the present invention is to provide a means for achieving the production of a customized book. In accordance with the invention, this objective is accomplished by enabling a User to select for customization, one of a plurality of previously stored (in memory) book stories that includes both text and imbedded illustrations. Some of the story text is referred to as “fixed text” in that it is text that will not be changed during implementation of the subject process, while some of the story text is referred to as “dynamic text” in that it is text that may be changed by the User as he customizes the book. Similarly, some of the illustrations, or portions thereof, are “fixed illustrations” and some are “dynamic illustrations” that may be changed in response to input provided by the User.

As used herein, customizable story data may include fixed or non-variable text data, fixed or non-variable graphics or image data, or composite fixed and/or variable text and graphics data.

Customizable text may be variously referred to as variable text or dynamic text, and customizable illustrations may be variously referred to as variable graphics, dynamic illustrations, dynamic images, etc.

Text that is non-changeable or non-customizable may be referred to as fixed text, and illustrations that are non-changeable or non-customizable may be referred to as fixed illustrations or fixed graphics. Combinations of the above may be referred to as composite text and/or graphics, composite fixed and variable text, composite fixed and variable graphics, etc.

Customizing data may include data in the form of textual inputs, image inputs, graphical inputs, temporal inputs, grammatical inputs, size color or shape inputs, gender inputs, etc.

Certain fixed and variable text components making up the story text i.e., the fixed illustration, or fixed illustration components linked thereto are automatically selected for the User. Alternatively, fixed illustrations and fixed text components can be separately selected. In one such embodiment, the User selects one or more fixed illustrations that can take many different forms. For example, a background illustration or similar illustration that would not need to be changed as the book is customized, could be a fixed illustration or component of an illustration. Customizing text data and image data regarding the subject story book is input to the system using the interface means 15.

In implementing the subject invention, one of the first steps taken by the User is the selection, as suggested by the box 30 in FIG. 2, of a story from a memory unit 28 containing data relating to a plurality of stories. The story may include both fixed and variable text, and fixed and variable images/graphics/illustrations. The User then proceeds to direct the customization of the story in the manner described below. The number of dynamic, or variable, text components available, “m”, could possibly be greater than the number of total text components, “n”, needed to form a complete story so that many different stories could be formed from the variable text components. That is, the User could select n variable text components from m available text components where m>n. In another alternative embodiment, the total text in a story is formed by the user selecting fixed text components.

In the customizable data of each story of the preferred embodiment, at least one fixed illustration is provided, and each fixed text component may be relationally linked with this fixed illustration. Thus, when the User selects story text or fixed text components making up the customizable story text, the fixed illustration, or fixed illustration components linked thereto are automatically selected for the User. Alternatively, fixed illustrations and fixed text components can be separately selected. In one such embodiment, the User selects one or more fixed illustrations that can take many different forms. For example, a background illustration or similar illustration that would not need to be changed as the book is customized, could be a fixed illustration or component of an illustration.

Customizing text data and image data regarding the subject story book is input to the system using the interface means 15. As discussed above, the customizing text data may include any form of text. For example, customizing text data may include names, places, things, activities, descriptions, or the like. Furthermore, the customizing text data may be input using a keyboard, mouse, scanner, camera, or other input device. In addition, the customizing text data may also be input by importing such data from another data source in an optional embodiment in which the input device is a communications device.

Regardless of how the customizing text data is acquired, following input, such data is stored in a File in memory 13 to await a call from the processor, as indicated by the box 32, for use in generating customized text, as indicated by the box 34. Following generation of the customized text as dictated by the customizing text data, the customized text and the fixed text are integrated by the processor 11, as indicated by box 36, to develop composite text, and made ready for combination with the image data used to develop the illustrations. Note that the customized text and fixed text need not have a one-to-one relationship and the customized text may be repeated within the fixed text in generating the composite text. It should be noted that the customized text need not necessarily have a one-to-one correlation with the customizing text data, and that the customizing text data may likewise be used repeatedly in generating the customized text. For example, if the customizing data includes a name, that name may be used repeatedly in the customized text.

Also, it is contemplated that in generating the customized text, such text may depend on the customizing text data without necessarily representing verbatim the customizing data. As an example, if the customizing text data indicates that the subject's gender is female, on subsequent references to the subject the data processor may selectively generate customized text using the pronoun “she” and the possessive pronoun “her” (as opposed to using the pronoun “he” and the possessive pronoun “his” when the customizing data indicates that the subject is male) by using the input gender data rather than requiring the user to input the pronoun and possessive pronoun for the female subject. In some embodiments, the composite text may be reviewed and edited prior to combination with the illustrations.

As will be further explained below, customizing image data input at the interface means 15 is stored in a file in the memory 13 to await a call from the processor 11. It should be noted that the customizing image data can be input using the same or a different input device 15 from that used to input the customizing text data. For example, while the customizing text data may be input at a keyboard input device 12, customizing image data may be input from a digital camera, scanner or other image capture means (none of which is shown). Alternatively, both customizing text data and customizing image data may both be input to memory 13 from a scanner.

Customizing image data can be selected by the User or consist of image data captured by any suitable type of input device. For example, the customizing image data may be data captured by a digital copy machine or acquired from a photograph scanned with a scanner. Regardless of how the customizing image data is acquired, following input at the interface means 15, such data is stored in memory 13 to await a call from the processor 11, as indicated by box 38, for use in generating at least one customized illustration, as indicated by the box 40.

The customized illustrations can be generated in a number of different ways. For example, the customizing image data may consist of a series of selections of stock features to generate a customized illustration incorporating the selected stock features. Such an aggregating process would be analogous to a paper doll decorating kit wherein a body shape framework is provided and the customizing image data are selections of certain facial, hair and clothing features taken from a list of stock items that the data processor adds to the framework.

Alternatively, the customizing image data may consist of digital image data. In such case, it is contemplated that the level of manipulation of the digital image could range greatly in generating the customized illustration. For example, a minimum of manipulation could take place by merely cropping and sizing the customizing image data to produce the customized illustration.

In a further example, the customizing image data is manipulated by the data processor to create a caricature or cartoon of the subject in the customizing image data. That is, features of the customizing image data may be used to generate a customized illustration based on the customizing image data through manipulation of the customizing image data.

In still another example, certain features of the customizing image data may be recognized by the data processor and used in generating a customized illustration based on the customizing image data, but using stock shapes rather than data manipulation. For example, based on the customizing image data showing a subject with short hair, round face, and green eyes, the data processor may select stock shapes representing the length of hair, shape of face, and color of eyes recognized from the customizing image data to generate the customized illustration.

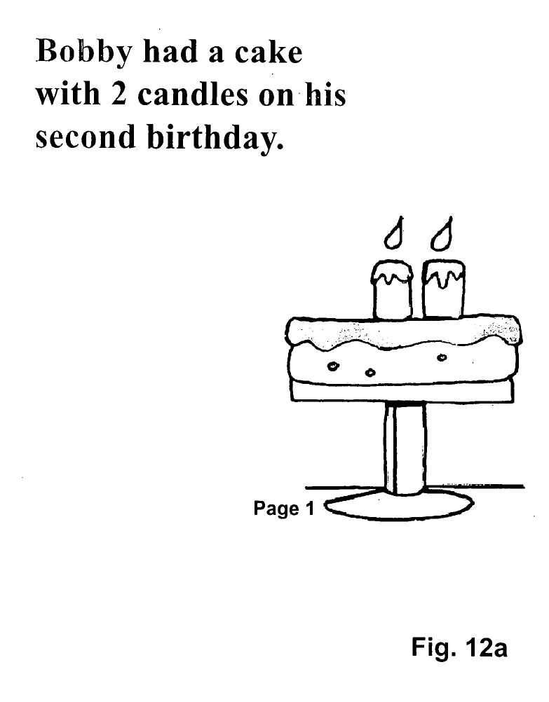

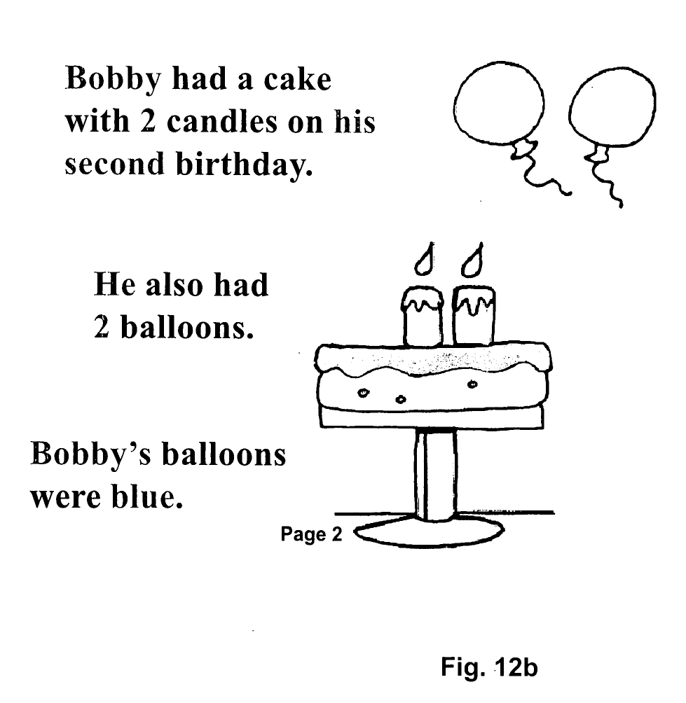

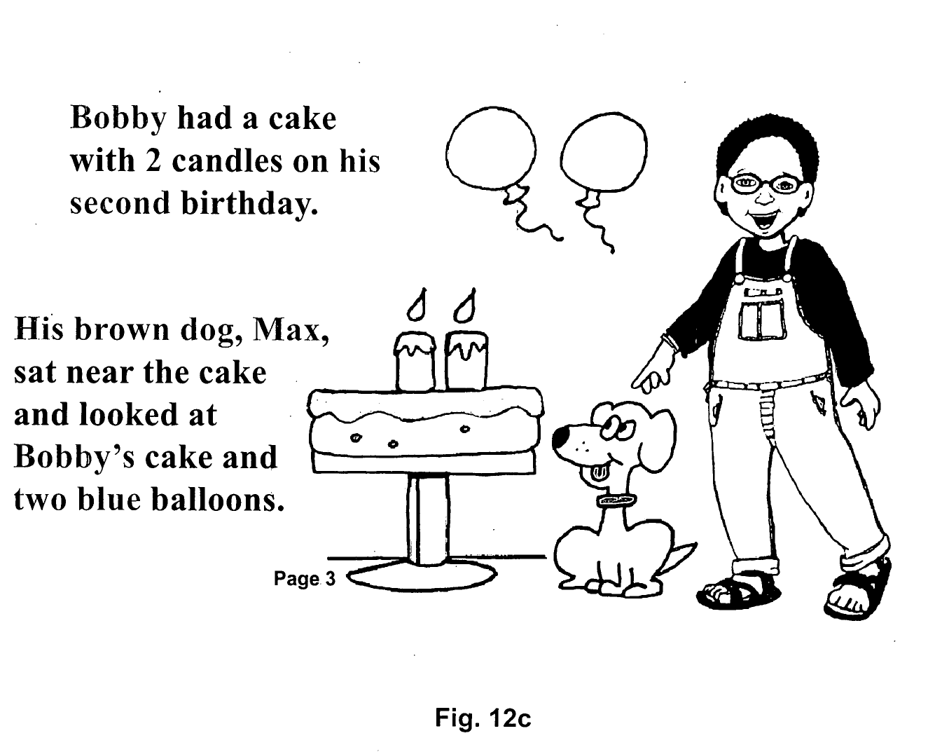

It should also be noted that the customizing text data may be combined with the customizing image data to generate a customized illustration including both text and image data. For example, as will be further addressed below with respect to FIGS. 12a-12c, if the customizing data indicates that the subject owns a brown dog, the customized illustration may be generated to include both an illustration of a brown dog and text referring to the brown dog.

At any rate, once the customized illustrations have been generated, as indicated by the box 40, the processor causes the customized illustrations and the fixed illustrations to be consolidated to form composite illustrations (box 42).

The next step in the process is to combine the composite text data and the composite illustrations data to generate customized book data as indicated by the box 44. As indicated by the box 46, the customized book data is then output to a final processing means such as the printer 20.

Customized book data is created by the data processor by combining the composite text with the customized illustrations. In one example, the customized book may also include fixed illustrations. In a further example, the customized illustration and fixed illustrations are integrated to generate composite illustrations. For example, if the customized illustration is a caricature of the Recipient, the caricature could be integrated into fixed illustrations of settings or backgrounds to create composite illustrations appropriate to the composite text. In another example, the customized illustrations and fixed illustrations may be handled separately. For example, fixed illustrations could appear on certain pages while a customized illustration appears on other pages.

The customized book data may optionally be available for review and editing by the User prior to its output to the printer 20. In such case, the reviewing and editing function might be achieved by communicating with the data via line 47 to the display screen 14, or to an alternative printer, or the like. For example, if the User intends the customized book to be read on a remote computer screen; an e-book, the output could be to a storage media in a data storage device associated with such apparatus.

In the illustrated embodiment, the output device 20 is a printing and book binding apparatus. In such an embodiment, the customized book data may be output to the printing component thereof for printing, and the printed pages assembled in a variety of ways. The composite text and customized illustrations, as well as a fixed illustrations, or composite illustrations, in an embodiment including such features, are formatted into pages. The pages are printed at the printer on sheets of paper; preferably both sides of a sheet of paper are printed on. It is also contemplated that more than one page may be printed on each sheet of paper. That is, pages may be printed in folios of two or more pages on each side of a sheet of paper. In such an embodiment, the folios are then folded along page breaks. The pages, or folios as the case may be, are sorted and assembled in the desired order into signatures of pages as suggested by box 48. Depending on the number of pages, more than a single signature may be created.

As suggested by box 50, a customized cover may also be created. The cover may be customized, such as by printing, or by adhering a customized label over a portion or all of the cover. The customized label could be generated using the same process as the customized book itself by combining customized text with fixed text to generate composite text alone, or with customized illustration, fixed illustration, or composite illustration.

In an example in which a customized adhesive label is adhered over only a portion of the cover, the remainder of the cover may be pre-printed. For example, as indicated by box 52, a hard cover book may be assembled by adhering a hard cover to the assembled book pages. Textual artwork for the customized cover is printed on an adhesive label and adhered to the hard cover to overlie a portion or all of the hard cover. Alternatively, a hard or soft cover book may be created by printing directly onto the cover material.

The customized book may be bound in many different ways. In one example, the signature or signatures can be nested in an adhesive sheet with adhesive on a surface facing outward from the pages and the assembly secured. Where fewer pages are present, staples may be used; where more pages are present, the customized book may be bound using adhesive and stitching, or the like. In such an embodiment, a cover might be attached to the adhesive sheet. In another embodiment, the book may be bound using a crimp binding process. One optional crimp binding process is called CHANNELBIND.®. in which a machine crimps the pages together.

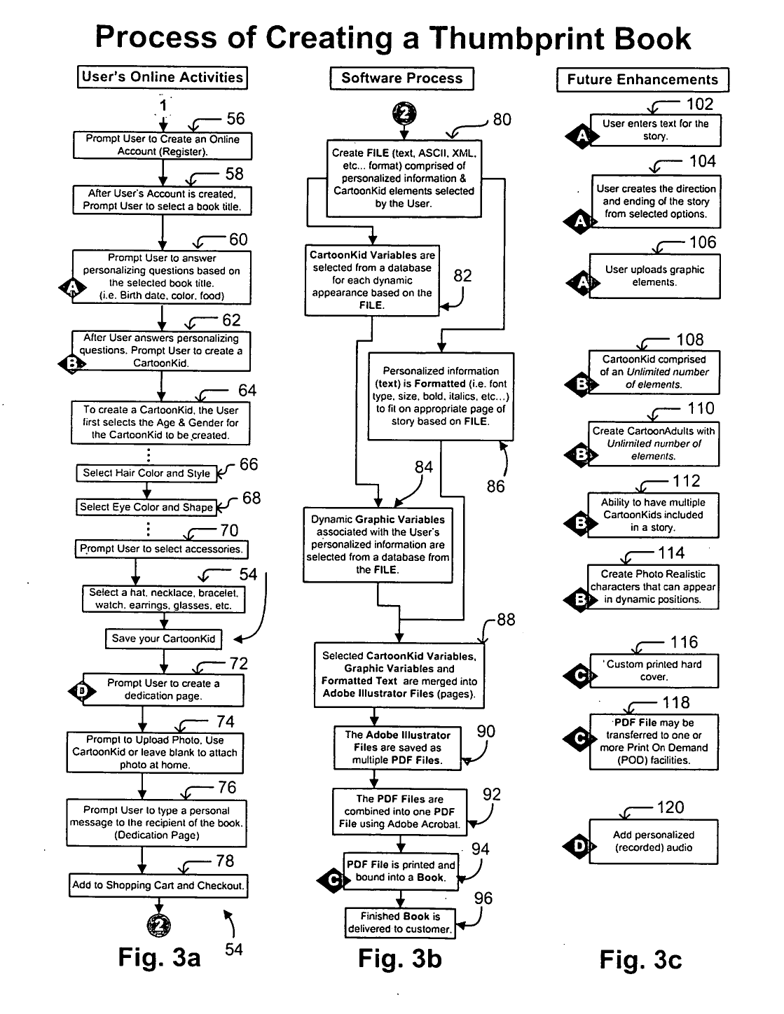

It will be appreciated that in addition to a book customizing process, a business method has been generally explained above wherein revenue can be generated in individual local and/or remote, network-connected embodiments. In either case, the User involvement is essentially the same and involves a User's input of customizing data relating to various attributes of the intended book recipient or his environment. This input process is laid out in more detail at 54 in FIG. 3a which is a flow chart illustrating in diagramatic form each step in the process of acquiring the necessary information needed to create a customized book in accordance with the present invention.

Also shown in FIG. 3b at 80 is a second flow chart illustrating in general the operation of the application software that uses the acquired information (customizing data) to generate the electronic data needed to produce the customized books.

By way of example, and in the case of a local embodiment wherein the revenue is generated in a kiosk or walk-up counter environment as depicted in FIG. 1, a User approaches the kiosk, reads the “attract” screen on the unit's customer interface (display screen 14), and determines that he wants to purchase a customized book as a gift for an upcoming occasion involving his young son. While the system is still in its attract mode, the User searches through an on-line or on-screen index or catalog of available books and selects the book he likes. At this point he can either insert the advertised cost (an amount of money) into the machine at 22, either as currency or credit card, or register and open a “User Account”. If he chooses to insert money or a credit card and not register, the machine switches from its attract mode to its information solicitation mode and prompts the User to answer “Personalizing Questions” based on the selected book title.

For example, in one embodiment he might be asked “Do you want to select a book or create a “CartoonKid”? A CartoonKid is the subject of the book's story and will be the focus in terms of variables for both text and graphics images. If he has not already selected a book title, by selecting one of a number of titles presented to him on the display screen, he must do so now.

On the other hand, if the kiosk is one of a plurality of kiosks linked together over the Internet, or a network of some other type, and in response to the prompt, and the User chooses to “Register” and open an “Online Account” (as per block 56 in FIG. 3a) he will be prompted (block 58) to supply the information needed to open the account. At this point the system will present a dialog screen prompting the User (block 60) to answer “Personalizing Questions” based on the previously selected book title.

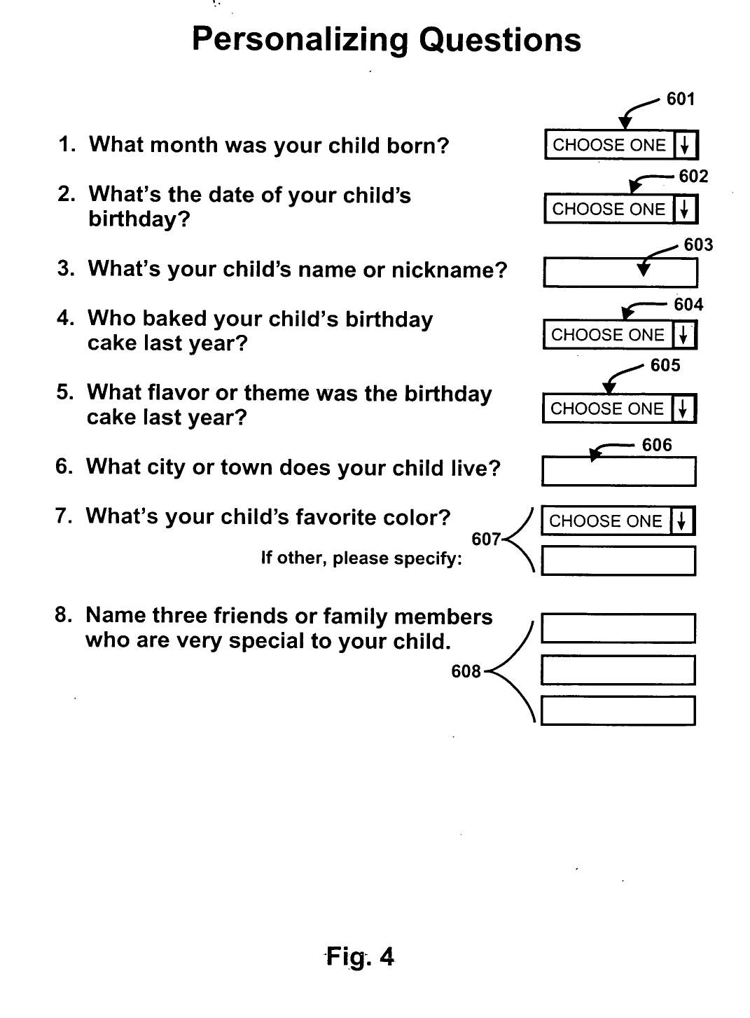

One such screen is depicted in FIG. 4 and asks “personalizing questions” concerning the intended “recipient” of the book, in this case his son. Relevant personalizing questions might include such informational items as the son's birth month (a pull down box 601), his birth date (a pull down box 602), his nickname (a dialog box 603), . . . his home town (a text entry field box 607), his favorite color (a pull down box 608), etc. The makeup of such informational items will vary with the story selected. This personalizing information is then stored in a “File” in the system memory and formatted (font size/color, bold, italics) to fit into dynamically shaped text blocks, or converted to text or proper pronoun usage [(his/her) (he/she) (3 years old/third Birthday)] to ultimately be merged into the text of the story.

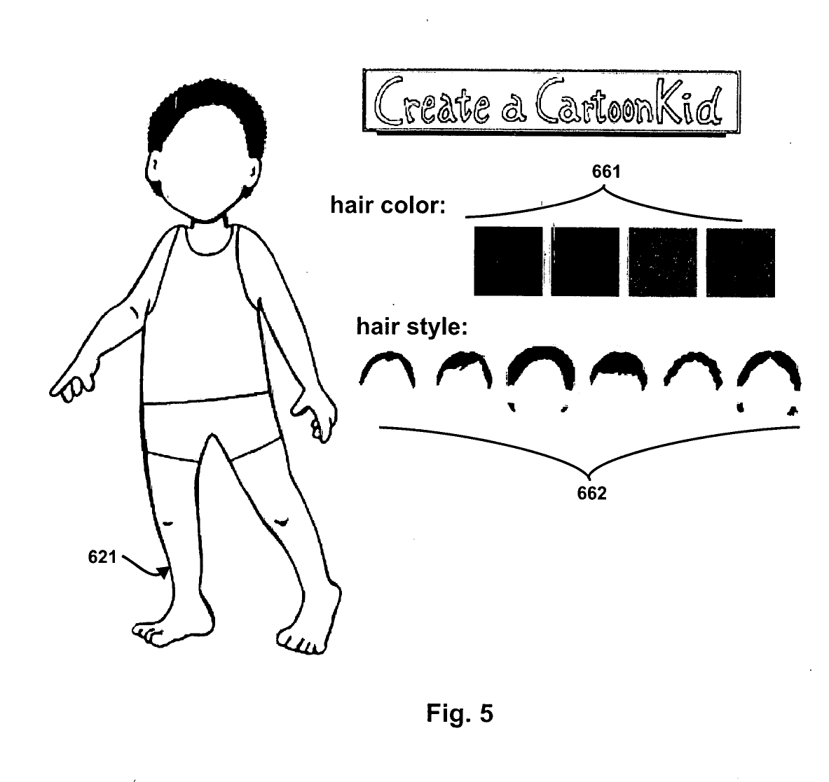

The User is then prompted at (62) to “Create a CartoonKid” and is presented with a screen display of a plurality of “Kid” primates (paper doll-like forms) like that shown at 621 in FIG. 5. The primates displayed will be in the form of basic body outlines of kids of various ages and body shapes, and will include kids of either sex. The User will be prompted (block 64, FIG. 3a) to choose a Kid shape that is at least suggestive of the “Recipient” of the customized book he is about to create, i.e., same age and gender.

Once the User has selected a Kid primitive, the system software will determine that the User has chosen either a boy or a girl, and will then use the previously input personalizing information to select, from the database, appropriate and corresponding sets of personalizing elements that extend over a range between one extreme and another, and include characterizing physical features, styles and types of clothing and accessories, etc., from which the User will be asked to select for use as the book is developed. The various sets of variables (elements) will normally be presented in terms of a series of display screens, such as those illustrated in FIGS. 5-8, which ask the User to select a particular “elemental variant” from each of several predetermined sets of elemental variants of “Kids” features, characteristics, etc., i.e., sets of different personal attributes, clothing styles and accessories stored in system memory.

More specifically, at the outset, a Kid starts off as a substantially blank outline figure of a child or other person” such as that shown at 621 in FIG. 5 but without the hair. The system database could include any number of “Kids” primates. In each of the screens shown as FIGS. 5-8, a series of choices of elemental variants for each of several distinguishing “elements”, i.e., hair color, hair style, clothes, shoes, accessories, etc., are depicted, and the User is prompted to choose one variant for each element for inclusion in the database “File”.

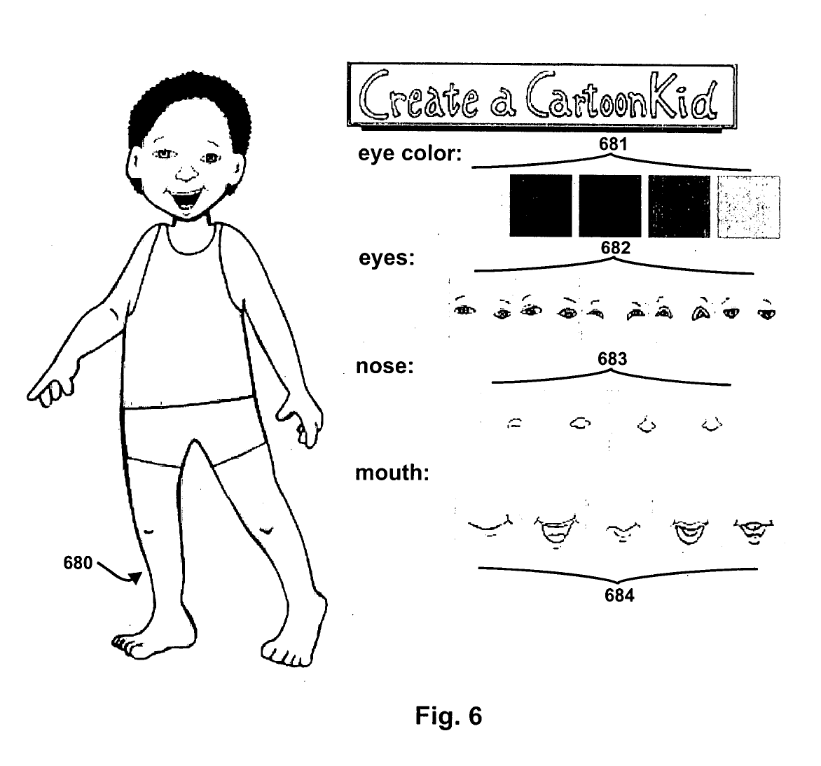

By way of example, in the screen of FIG. 5, the selected Kid primate is shown at 621 and the User is prompted to pick one variant of the Kid's hair colors depicted at 661, and one variant of the Kid's hair styles illustrated at 662. As he does so, the Kid figure (at 621) is “adorned” or “populated” with the selected physical characteristics. This information is then saved to the data File, and the screen is changed to that depicted in FIG. 6. The User is again prompted to select a variant corresponding to the Kid's eyes color (681), eyes type (682), nose type (683) and mouth type (684).

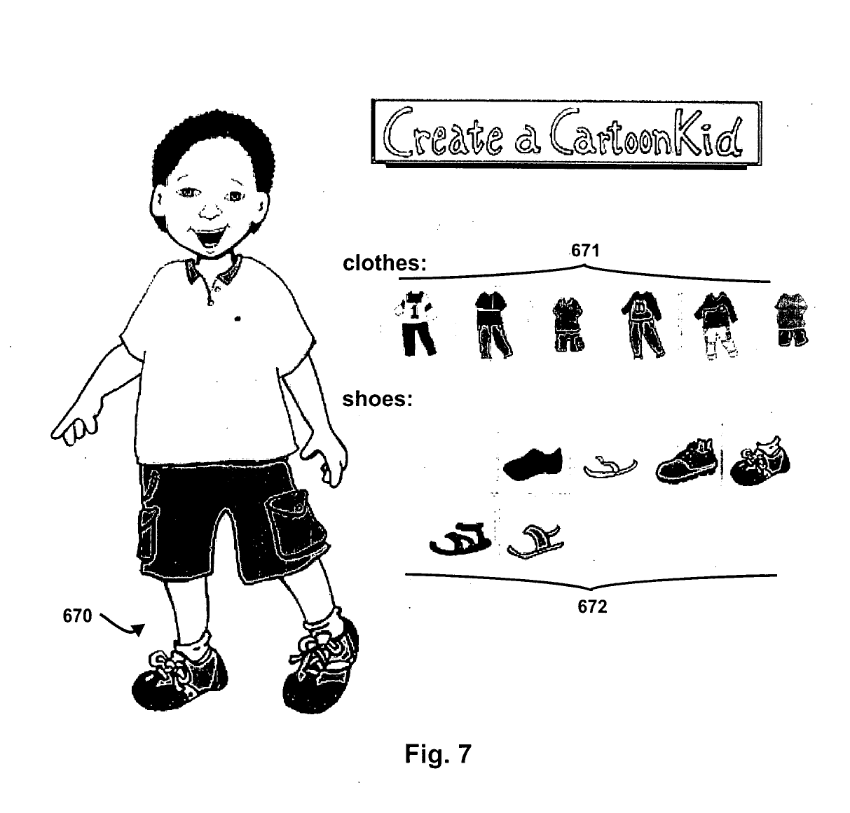

Next, the screen is again changed to that depicted in FIG. 7 showing the Kid at 670, and the User is prompted to select a variant corresponding to the Kid's favorite clothing style (671) and shoe style (672). Again the Kid is adorned with the selected clothing and the data is saved to File.

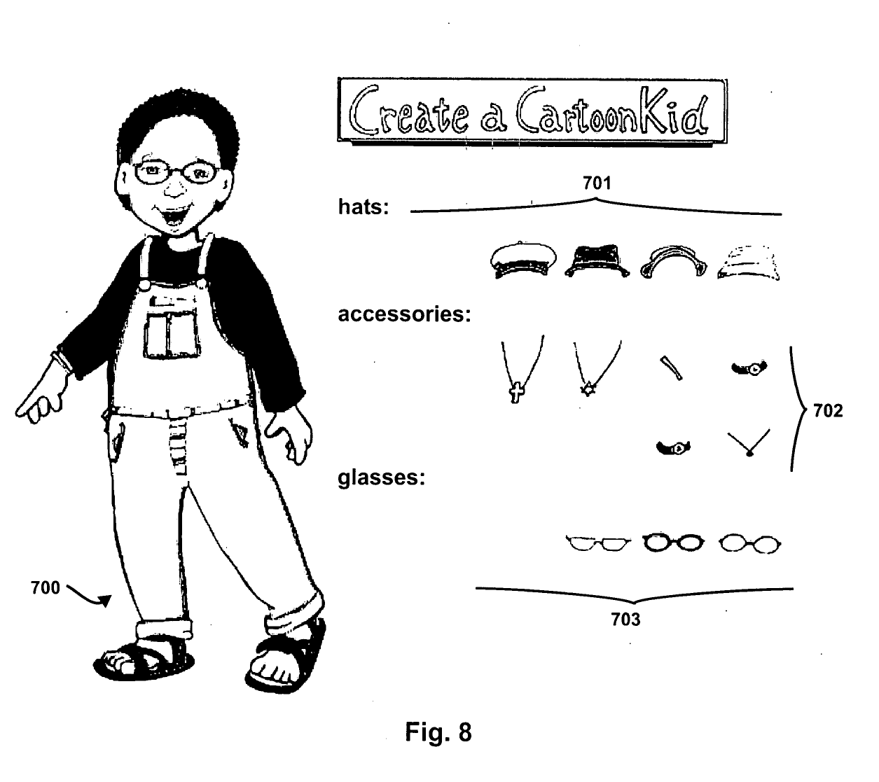

In the following screen, the Kid is shown at 700, in FIG. 8, and the User is prompted to select a variant corresponding to the Kid's favorite accessories including hat type (701), jewelry type (702) and glasses style (703), if any. Other categories of customizing features and characterizing elements may also be provided for additional choices. For example dogs or cats and their colorations, etc., might be included.

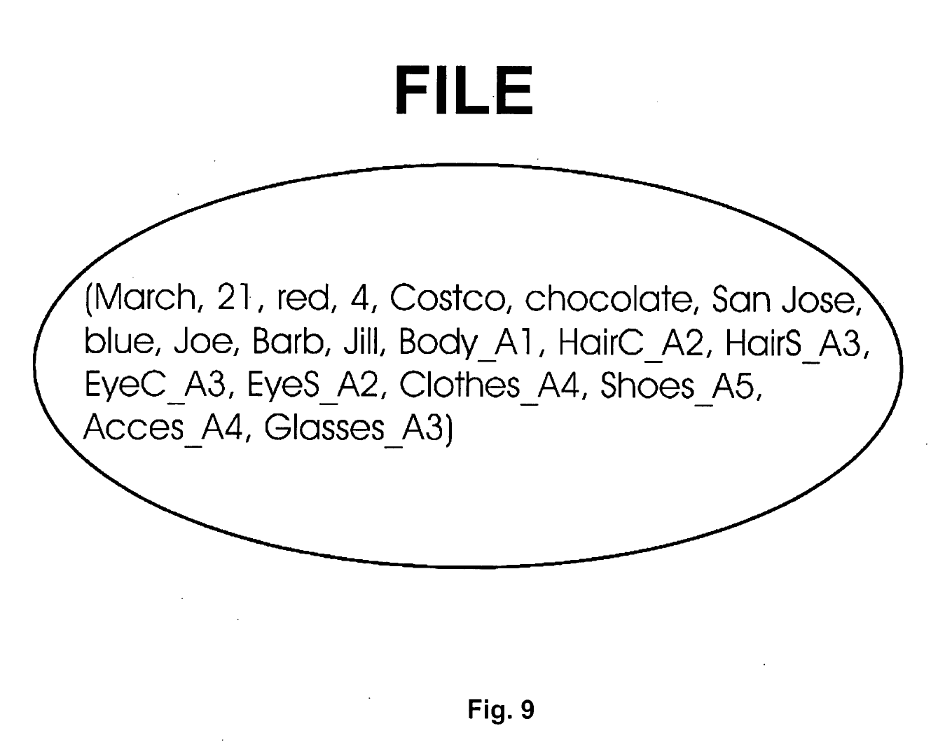

And finally, once the CartoonKid selections have been made, the User is prompted at 72, FIG. 3a, to (optionally) create a dedication page by uploading a photo of his son (Recipient) at 74, and typing in a personal message at 76. The User then adds the information to his “Shopping Cart” at 78, and “Checks Out”. Note that the act of “adding information to his Shopping Cart” is the same function as “Saving to File”. Saving to File means sending all of the selections to memory to be saved in a data File such as that illustrated in FIG. 9. Checking out may include the payment step, or perhaps finalize the payment process.

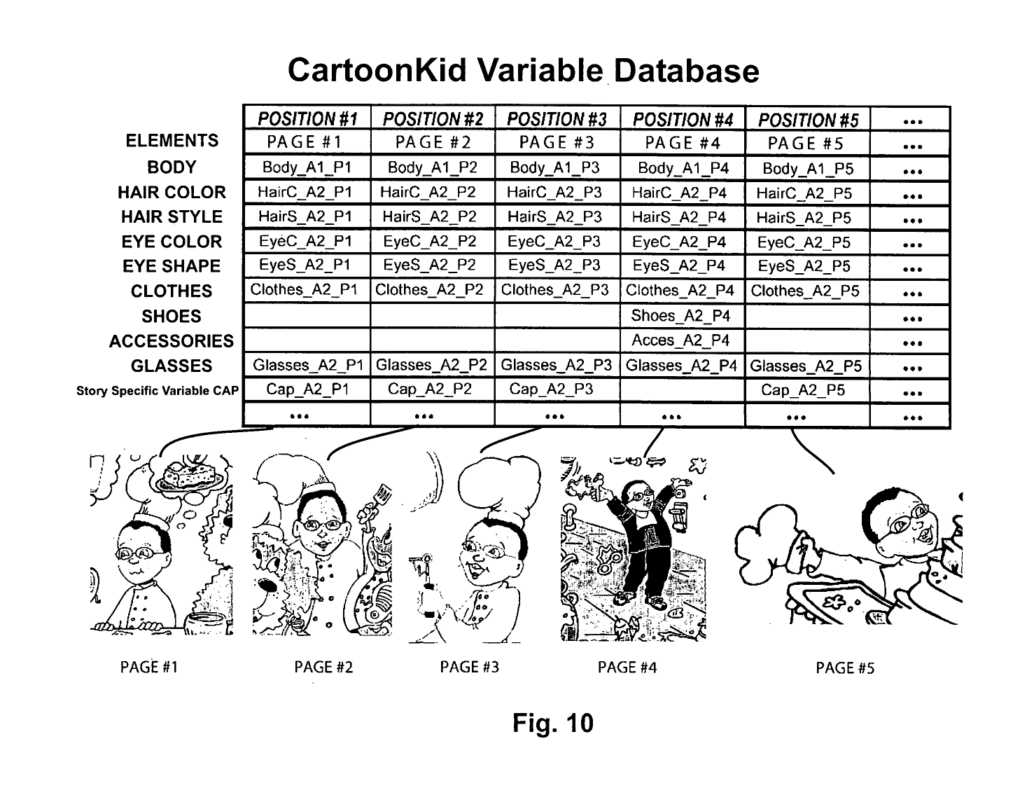

Having completed the customizing input phase of the process, the system software takes over the process and begins to carry out the customizing process outlined in FIG. 3b. During the original construction of each book, in addition to the fixed and variable text mentioned above, several illustrations containing customizing variables are included among the text. The variable attributes of these illustrations are identified and assembled into a CartoonKid Variable Database such as that depicted in FIG. 10. Then, as the variants mentioned above are selected by the User, they are used by the system software to populate the CartoonKid Variable Database with the selected variants so that when the software calls up each illustration during the book assembly operation, the dynamic parts of the illustrated CartoonKid and his environment are displayed with elements corresponding to those variants earlier selected by the User. The resulting customized or stylized variables in dynamic appearance illustrations will be included on various pages of the book. See for example, the “populated” illustrations shown beneath each column of the database in FIG. 10.

Similarly, when personalized information is used in association with fixed graphics data, a Graphic Text Database is constructed in memory.

As described above, in the preferred embodiment, at least one fixed illustration is utilized in each story, and both fixed and variable text components are relationally linked with the fixed illustrations.

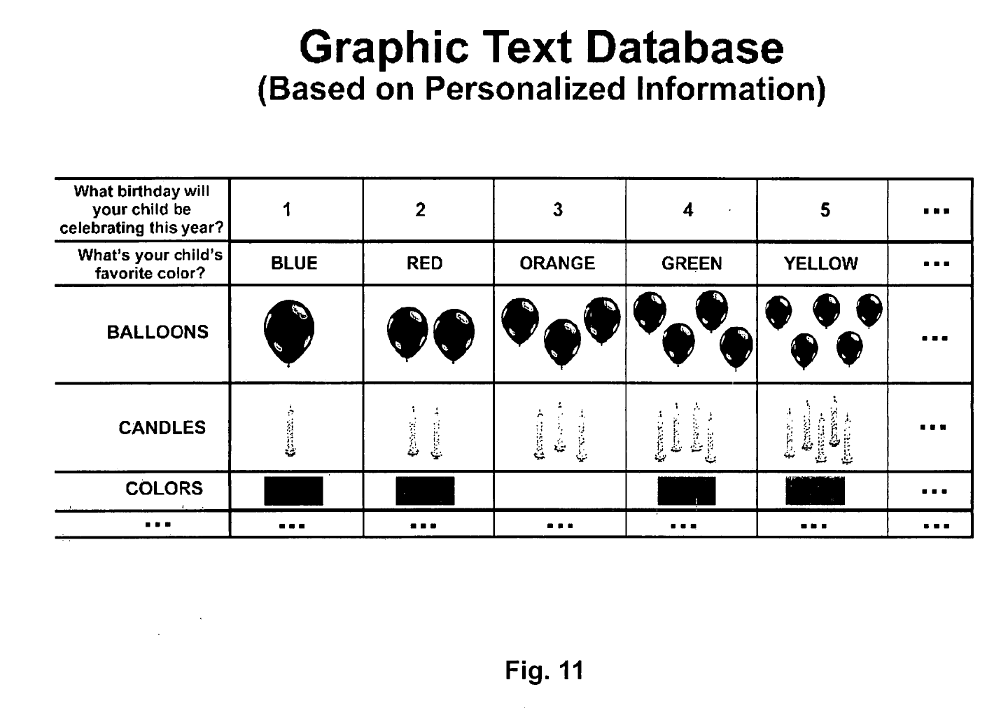

Thus, when the User has selected a particular story text and has input data to the File (FIG. 9) that will impact the variable text components and the associated fixed graphics components thereof, a Graphic Text Database such as that illustrated in FIG. 11 will be constructed in memory. Consequently, when called, the correct combination of elements and their attributes will be gathered and assimilated on particular pages. For example, if Bobby was the Recipient and he was celebrating his second birthday, his favorite color was red, and his dog's name was Max, he might get two candles on his cake, two red balloons, and his dog Max would be included. Such data would be stored in the File of FIG. 9, and the Graphic Text Database of FIG. 11, so that when pages 1-3 of the book (illustrated as FIGS. 12a-12c) are being assembled, the 2 candles graphic shown in FIG. 12a will be used on page 1, the two red balloons will be added on page 2 (FIG. 12b), and the brown dog Max will be added on page 3 (FIG. 12c). In addition, the variable text “Bobby”, “2”, “his”, “second”, “red”, and “brown dog Max” as illustrated in pages 1-3 will also be “customized”.

The software process of FIG. 3b starts with the creation of the data File illustrated by the block 80 which, as previously expressed, is in text, ACSII, XML, etc., . . . format, is comprised of personalized information and CartoonKid elements selected by the User. The application software then executes the customization routine for the selected story by selecting CartoonKid Variables from a database for each dynamic appearance based on the File, as evidenced by block 82. Dynamic Graphic Variables associated with the User's personalized information are selected from a database from the File, as depicted in block 84.

As shown by block 86, personalized information (text) is Formatted (i.e., in terms of font type, size, bold, italics, etc., . . . ) to fit on the appropriate page of the story based on the File data.

As the book production progresses (block 88), selected CartoonKid variables, Graphic Variables and formatted text are merged into Adobe Illustrator Files (pages). And the Adobe Illustrator files are saved as multiple PDF Files (block 90). The PDF Files are then combined into one PDF File using Adobe Acrobat (block 92), the PDF File is printed and bound into a book (block 94), and the finished book is delivered to the customer.

Returning now to FIG. 3c, further additions and future enhancements to the above described embodiment and variations thereof are suggested. For example, although as described above, the input of personalizing data at block 60 in FIG. 3a has been indicated as including birth date, color and food, as suggested in FIG. 3c at 102, the User might also be permitted to input additional text for the story, or perhaps even the entire text for the story. Similarly, as indicated in block 104, the User might be permitted to create or otherwise modify the direction and ending of the story. And as proposed at 106, the User could even upload additional graphics elements to alter, augment, supplement or even supplant the original story graphics.

In addition, as indicated at 108, the User might be permitted to characterize his CartoonKid by selecting from an almost unlimited number of characterizing elements, or as indicated at 110 and 112, he might be given the choice to create a CartoonAdult or multiple CartoonKids or CartoonAdults for inclusion in his book story. Moreover, he might be allowed to create photo realistic characters that appears in dynamic or even dynamically changing positions as proposed at 114.

It is also contemplated that as indicated at 116, the User might be allowed to design a custom, printed hard cover. At 118, transferring a PDF File of the User's book to one or more Print On Demand (POD) facilities for final production may be implemented to provide scalability and decrease delivery time.

Although it is recognized that numerous alterations and modifications to the invention described herein may become apparent to those skilled in the art after having read the above disclosure, it is intended that this disclosure be by way of example and not limitation, and that the appended claims be interpreted to cover all such alterations and modifications as fall within the true spirit and scope of the invention.

1. A method of developing a customized story book comprising:
providing a data processor;
providing a data storage device in communication with said data processor, said data storage device having data stored therein relating to at least one book story including fixed text data, variable text data and data relating to at least one illustration, said data storage device also having a book customizing application program stored therein;
providing a user interface device in communication with said data processor;
providing an output device in communication with said data processor;
inputting customizing data to said data processor via said interface device; and
causing said data processor to execute said application program and use said customizing data to alter said variable text data to generate customized text data; and to generate composite text data by integrating said customized text data and said fixed text data; said data processor further integrating said composite text data and said illustration data to develop customized story book data, and outputting said customized story book data to said output device.

2. A method of developing a customized story book as recited in claim 1 and further comprising:
causing said output device to use said customized story book data to develop a customized book.

3. A method of developing a customized story book as recited in claim 2 wherein said output device is a printer capable of using said customized story book data to print a customized story book.

4. A method of developing a customized story book as recited in claim 1 wherein said illustration data includes fixed illustration data and variable illustration data, said variable illustration data having been altered by said customizing data to generate customized illustration data that was integrated with said fixed illustration data to generate composite illustration data that was integrated with said composite text data to develop said customized story book data.

5. A method of developing a customized story book as recited in claim 1 wherein said illustration data includes fixed illustration data and variable illustration data, and wherein said method further comprises:
causing said data processor
to use said input customizing data to alter said variable illustration data to generate customized illustration data; and
to generate composite illustration data by integrating said customized illustration data and said fixed illustration data, and to integrate said composite illustration data and said composite text data to develop said customized story book data.

6. A method of developing a customized story book as recited in claim 5 wherein said customizing data includes personalizing information relating to an intended recipient of the customized book.

7. A method of developing a customized story book as recited in claim 6 wherein said personalizing information includes data relating to the recipient's statistical information and physical characteristics

8. A method of developing a customized story book as recited in claim 7 wherein said personalizing information further includes data relating to the recipient's preferences in various categories.

9. A method of developing a customized story book as recited in claim 1 wherein said output device is a data storage device.

10. A method of developing a customized story book as recited in claim 1 wherein said output device is a remotely located printing device.

11. A method of developing a customized story book as recited in claim 1 wherein said data storage device has data stored therein relating to a plurality of book stories including fixed text data, variable text data, fixed image data and variable image data.

12. A business method for earning revenue by customizing and selling customized books, comprising:
providing a data processor;
providing a data storage device in communication with said data processor, said data storage device having stored therein a plurality of discrete quantities of book data, wherein each said quantity of book data includes text data and image data relating a particular story;
providing a user interface device in communication with said data processor and said data storage device and accessible by a user in exchange for the payment of a fee;
providing an output device in communication with said data processor and said storage device;
providing an application program for use by said data processor device and operative to cause a story identifying reference to each said quantity of book data to be displayed to the user on said interface device, said application program being further operative to allow the user to select a particular one of the stories associated with said story identifying references and to input customizing data into said data storage device; said customizing data relating to certain customizable features associated with the selected story, said application being further operative in response to said customizing data to modify said customizable features to develop customized story data and to send said customized story data to said output device for conversion into a form suitable for delivery to the user.

13. A business method as recited in claim 12 wherein said output device is a recording device and said form suitable for delivery to the user is an audio/video recording that can be played by the user or a recipient thereof.

14. A business method as recited in claim 12 wherein said output device is a printing device and said form suitable for delivery to the user is a printed book.

15. A business method as recited in claim 12 wherein said text data includes fixed text data and variable text data, said variable text data being alterable by said data processor in response to said customizing data to produce customized text data.

16. A business method as recited in claim 12 wherein said image data includes fixed image data and variable image data, said variable image data being alterable by said data processor in response to said customizing data to produce customized text data.

17. A business method as recited in claim 14 wherein said image data includes fixed image data and variable image data, said variable image data being alterable by said data processor in response to said customizing data to produce customized image data.

18. A computer-readable storage medium containing an applications program including a set of instructions for a general purpose computer having a user interface including a keyboard, mouse and a display screen, and an output interface for generating a display on said display screen and/or for driving a printer, the set of instructions relating to a process for creating a customized story book including a story involving a generated character, comprising:
an input routine operatively associated with said user interface for permitting a user to select icon(s) displayed on said screen display, said icon(s) associated with said applications program;
a run routine for implementing said applications program selected by the user, said applications program permitting the user to
a) select a story to be customized in a way that causes the generated character to resemble a particular person, said story being embodied in a form including fixed text, variable text, and at least one variable image;
b) provide personalizing information relating to said person;
c) select a body style for said character resembling the body of said person;
d) select body features and characteristics, clothing styles and accessories resembling those of said person;
e) use the personalizing information, selected body style and selected body features and characteristics, clothing styles and accessories to modify the variable text and variable image; and
f) use the fixed text, the modified text, and the modified image to generate data corresponding to a customized story book; and
a display/print routine responsive to said data for displaying on said screen display, or printing on print media, text and images generated by said applications program and forming said customized story book.

19. A computerized process of producing a customized book, comprising the steps of:
selecting one of a plurality of previously developed stories having fixed text and variable text, and associated fixed illustrations and variable illustrations;
inputting certain customizing information to the computer;
using the input customizing information to personalize the story and accompanying illustrations by modifying said variable text and said variable illustrations so that they relate to an intended recipient of the book;
using the modified text and illustrations to develop customized text and associated customized illustrations;
integrating the customized text and associated customized illustrations with the fixed text and fixed illustrations to produce customized book data; and
using the customized book data to produce a customized book.
